(19) United States
(12) Patent Application Publication
(10) Pub. No.: US 2026/0261840 A1
(43) Pub. Date: Sep. 3, 2026

(54) OPERATING MODES AND UNAVAILABILITY SCHEDULES TRANSFER DURING ROAMING

(71) Applicant: Cisco Technology, Inc., San Jose, CA (US)

(72) Inventors: Binita Gupta, San Diego, CA (US); Brian D. Hart, Sunnyvale, CA (US)

(73) Assignee: Cisco Technology, Inc., San Jose, CA (US)

(21) Appl. No.: 19/552,457

(22) Filed: Feb. 27, 2026

Related U.S. Application Data
(60) Provisional application No. 63/765,191, filed on Feb. 28, 2025.

(51) Int. Cl. H04W 8/14; H04W 4/90; H04W 76/15

(52) U.S. Cl. CPC H04W 8/14; H04W 4/90; H04W 76/15

(57) ABSTRACT

Operating modes and unavailability schedules transfer during roaming may be provided. An access point multi-link device (AP MLD) receives a roaming request from a non-AP MLD indicating links to setup with a target AP MLD, information for establishing one or more operating modes and associated operating parameters for the one or more links, and/or information for establishing one or more unavailability periods for the one or more links. The AP MLD transmits to the target AP MLD an indication for establishing the operating modes and associated operating parameters, an indication for establishing the unavailability periods, or both. The AP MLD receives a status indication indicating whether the operating modes and associated operating parameters were successfully established, whether the unavailability periods were successfully established, or both and transmits roaming response comprising the status indication to the non-AP MLD.

### RELATED APPLICATION

Under provisions of 35 U.S.C. § 119(e), Applicant claims the benefit of and priority to U.S. Provisional Application No. 63/765,191, filed February 28, 2025, the disclosure of which is incorporated herein by reference in its entirety.

### TECHNICAL FIELD

The present disclosure relates generally to providing operating modes and unavailability schedules transfer during roaming.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for operating modes and unavailability schedules transfer during roaming in accordance with aspects of the present disclosure.

FIG. 2 illustrates a seamless roaming process in accordance with aspects of the present disclosure.

FIG. 3 is a message exchange diagram illustrating a procedure for operating modes and unavailability schedules transfer during roaming in accordance with aspects of the present disclosure.

FIG. 4 illustrates an operating mode mapping indication format in accordance with aspects of the present disclosure.

FIG. 5 illustrates an operating mode status indication format in accordance with aspects of the present disclosure.

FIG. 6 illustrates an unavailability period mapping indication format in accordance with aspects of the present disclosure.

FIG. 7 illustrates and unavailability period status indication format in accordance with aspects of the present disclosure.

FIG. 8 is a flow diagram illustrating a method for facilitating operating modes and unavailability schedules transfer during roaming in a wireless network in accordance with aspects of the present disclosure.

FIG. 9 is a flow diagram illustrating a method for requesting operating modes and unavailability schedules transfer during roaming in a wireless network in accordance with aspects of the present disclosure.

FIG. 10 is a block diagram of a computing device in accordance with aspects of the present disclosure.

FIG. 11 is a block diagram of a communications device in accordance with aspects of the present disclosure.

### DETAILED DESCRIPTION

### OVERVIEW

Operating modes and unavailability schedules transfer during roaming may be provided. An access point multi-link device (AP MLD) receives a roaming request from a non-AP MLD indicating links to setup with a target AP MLD, information for establishing one or more operating modes and associated operating parameters for the one or more links, and/or information for establishing one or more unavailability periods for the one or more links. The AP MLD transmits to the target AP MLD an indication for establishing the operating modes and associated operating parameters, an indication for establishing the unavailability periods, or both. The AP MLD receives a status indication indicating whether the operating modes and associated operating parameters were successfully established, whether the unavailability periods were successfully established, or both and transmits roaming response comprising the status indication to the non-AP MLD.

Both the foregoing overview and the following example embodiments are examples and explanatory only and should not be considered to restrict the disclosure’s scope, as described, and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Roaming in Wi-Fi networks occurs when a client device (e.g., a Station (STA) or a non-Access Point Multi-Link Device (non-AP MLD)) transitions its connection from one Access Point (AP) or AP MLD to another, typically because the client device has moved outside the range of its serving AP or has identified another AP that can provide a better connection. Roaming decisions are primarily made by client devices based on Received Signal Strength Indicator (RSSI) measurements, supplemented by network recommendations from the serving AP regarding suitable neighbor APs.

Seamless roaming techniques have been developed to reduce roaming latency and improve user experience during AP transitions. Traditional non-Multi-Link Device (MLD) seamless roaming techniques include those described in Institute of Electrical and Electronics Engineers (IEEE) 802.11k, which reduce the time required to roam by enabling a client to more quickly determine which AP it should roam to next, with the serving AP providing information regarding neighboring APs and their channels. Another non-MLD technique is described in IEEE 802.11r, which uses Fast Basic Service Set (BSS) Transition (FT) to allow encryption keys to be stored on all of the APs in a network, enabling a client device to avoid performing the complete authentication process to a backend server every time it roams to a new AP within the network, thus reducing authentication-related latency.

MLD-based seamless roaming as defined in the IEEE 802.11bn amendment introduces Seamless Mobility Domains (SMDs), which are logical, secure groupings of multiple AP MLDs that enable client devices to roam between them without disconnecting, re-authenticating, re-associating, or experiencing packet loss. MLD-based seamless roaming enables a “make-before-break” approach where a device establishes a connection to a new AP MLD before releasing the old one by utilizing multiple links. This allows the client device to maintain connectivity during the transition, as the client can communicate with both the serving AP MLD and the target AP MLD over different links. The IEEE 802.11bn seamless roaming procedures include a roaming preparation phase during which the client device and serving AP exchange signaling to prepare one or more target APs for the upcoming roaming transition, followed by a roaming execution (or roaming transition) phase during which the actual transition to the target AP occurs. The roaming preparation phase may include negotiation of target APs, establishment of security associations with target APs, preparation of link configurations at the target APs, and context transfer to the target APs, enabling the subsequent roaming execution to occur with minimal latency and data loss.

With advancements in wireless networking operations, particularly those described in the IEEE 802.11bn standard for Ultra High Reliability (UHR) wireless communication systems, multiple new link-specific features and operating modes have been introduced to enhance communication between APs and client devices. These operating modes include Dynamic Power Save (DPS) mode, Dynamic Unavailability Operation (DUO) mode (which may be triggered by in-device coexistence (IDC) considerations), Periodic Unavailability Operation (PUO) mode, Limited Operation mode (also referred to as Adaptive Operation Mode (AOM)), Non-Primary Channel Access (NPCA) mode, Dynamic Subchannel Operation (DSO) mode, and Dynamic Bandwidth Expansion (DBE) mode, Low Latency Indication (LLI) mode, Prioritized-Enhanced Distributed Channel Access (P-EDCA) mode, among others. Each of these operating modes is link specific, and a client device explicitly enables these features and operating modes with its serving AP MLD on a per-link basis. Each operating mode provides distinct functionality to optimize wireless communication performance under varying conditions, such as power consumption, spectrum efficiency, interference mitigation, and quality of service.

Because client devices can perform seamless roaming within an SMD without re-association or re-authentication, the target AP MLD may be unaware of which operating modes the non-AP MLD has enabled and on which links. Without transferring or (re)negotiating these operating modes during the roaming process, the non-AP MLD would be unable to utilize the enabled operating modes when transitioning to the target AP MLD until it performs operating mode setup and/or update processes after roaming. This post-roaming operating mode configuration would introduce additional delay and signaling overhead, potentially degrading user experience and network efficiency during the roaming transition.

Similarly, unavailability reporting is a mechanism in UHR networks that allows client devices to notify other devices (including the serving AP) about time intervals when they are unavailable for communication, such as due to IDC constraints or peer-to-peer activity. APs and other devices can leverage this information to avoid transmitting frames during these times or to switch off their radios to save power. To accommodate both periodic and aperiodic traffic patterns, PUO and DUO modes can be used to signal periodic unavailability and dynamic unavailability. Within the DUO mode, client devices dynamically indicate unavailability start times and durations at the beginning of a transmit opportunity (TXOP) or during the TXOP in modified frames, such as buffer status report (BSR) poll tigger frames or multi-STA Block Acknowledgement frames. Since DUO signaling is dynamic and occurs during ongoing communication, the target AP may not need prior awareness of any signaling associated with the DUO mode during the transition. However, within the PUO mode, client devices establish periodic unavailability schedules that define service periods during which the client device will be unavailable. These periodic unavailability schedules can be established for substantial lengths of time, including periods that extend beyond when a client device performs roaming to a target AP MLD. Without transferring PUO schedule information to the target AP MLD during roaming, the target AP would be unaware of when the client device will be unavailable, potentially leading to inefficient downlink transmissions, wasted network resources, and disruption to the client’s periodic unavailability pattern.

Additionally, Emergency Preparedness Communications Service (EPCS) priority access, as defined in Wi-Fi 7 (IEEE 802.11be), allows certain client devices, such as those used by emergency workers, to receive prioritized network access during emergency situations. When a client device has enabled EPCS priority access with its current AP MLD, maintaining this priority access state during roaming to a target AP MLD is critical to ensure continuous prioritized communication during emergency response scenarios.

The techniques described herein address these challenges by enabling client devices to transfer and/or (re)negotiate operating modes and related parameters with the target AP MLD during roaming preparation and/or roaming execution phases. This enables the client device to continue operating in these operating modes without the added delay of performing operating mode setup or updates after roaming. Additionally, the techniques enable client devices to transfer or (re)negotiate long-term periodic unavailability schedules during roaming, ensuring continuity of unavailability reporting without disruption or the need for re-establishment after roaming. Further, the techniques enable transfer or setup of EPCS priority access state on the target AP MLD, ensuring uninterrupted priority access during emergency scenarios.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or,” “and/or,” “at least one of,” and “one or both of” as used herein are to be interpreted as inclusive or meaning any one or any combination. Therefore, “A, B, or C” or “A, B, and/or C” mean “any of the following: A; B; C; A and B; A and C; B and C; A, B and C.” An exception to this definition will occur only when a combination of elements, functions, steps, or acts are in some way inherently mutually exclusive.

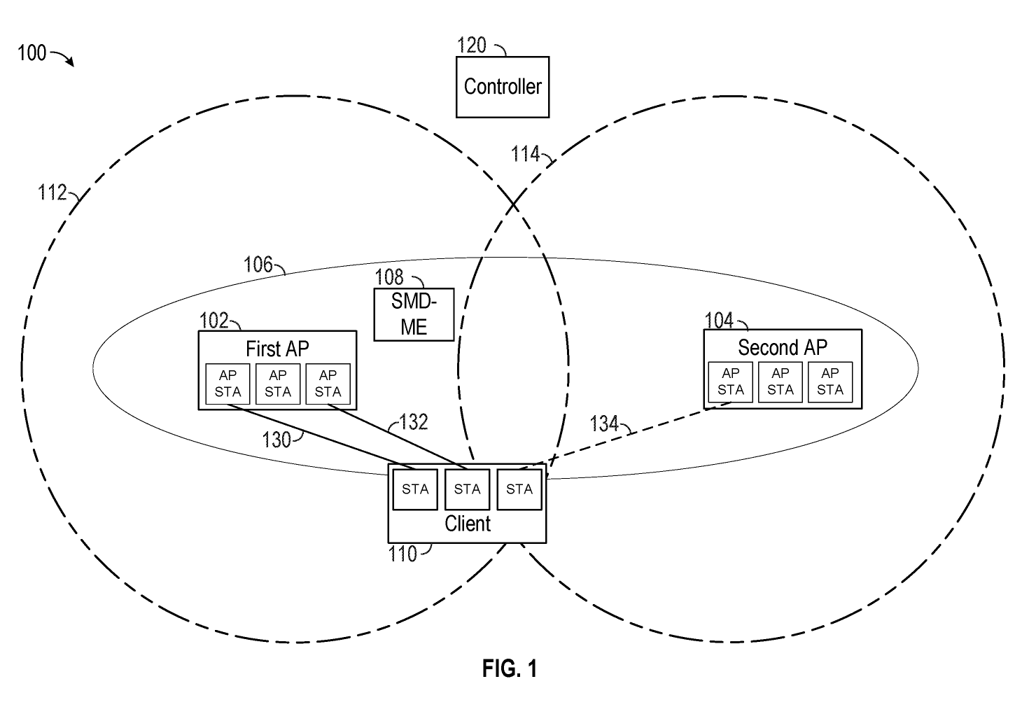

FIG. 1 is a block diagram of an operating environment 100 for transferring operating modes, parameters, and unavailability schedules during seamless roaming. In the illustrated embodiment, the operating environment 100 includes a first AP 102, a second AP 104, a client device 110, and a controller 120. The first AP 102 has a service area or cell indicated by the first cell 112, and the second AP 104 has a service area indicated by the second cell 114. The range of the first AP 102 and the second AP 104 may extend past the boundaries of the associated cells, resulting in overlapping coverage, but the signals grow weaker as devices move away from the respective APs. The edges of the first cell 112 and the second cell 114 as shown in the operating environment 100 are examples and may be different in other implementations (e.g., different sizes, shapes, etc.).

The APs in the operating environment 100 are grouped into one or more SMDs, such as the SMD 106 in the illustrated embodiment. The SMD 106 provides seamless roaming to clients across AP MLDs within the SMD 106. A client device 110 associates at the SMD level with an SMD-Management Entity (SMD-ME) 108 within the SMD 106 and then roams between AP MLDs within the SMD 106 without performing reauthentication or reassociation, to achieve seamless roaming. The first AP 102 and second AP 104 are part of the same SMD 106 in the illustrated embodiment.

The client device 110 is any device that connects to the network to communicate with other devices on the network, such as a smartphone, a tablet, a personal computer, a laptop, an Internet of Things (IoT) device, and/or the like. As illustrated in FIG. 1, the client device 110 is currently associated with the SMD 106 (e.g., via the SMD-ME 108), within the first cell 112, and connected with the first AP 102. However, the client device 110 may be moving toward the boundary of the first cell 112 and into the second cell 114, indicating that the client device 110 may soon need to roam from the first AP 102 to the second AP 104 or another neighbor AP to maintain network connectivity and quality of service (QoS).

An AP, such as the first AP 102 and the second AP 104, is generally a fixed station that communicates with client devices and may also be referred to as a base station, wireless device, or some other terminology. The APs support seamless roaming procedures (e.g., as defined in the IEEE 802.11bn amendment), including roaming preparation and roaming execution (or roaming transition) phases, which enable the client device 110 to transition between APs (e.g., AP MLDs) within the same SMD 106 with reduced roaming latency and data loss. The controller 120 may be any network controller (e.g., a WLAN controller) and may manage the first AP 102, the second AP 104, the SMD 106, the SMD-ME 108, and/or other network devices (not shown) to allow wireless devices such as the client device 110 to connect to the network. In some embodiments, the operations of the controller 120 described herein may be performed by one or more of the first AP 102, the second AP 104, and/or another device, and vice versa. In some embodiments, the controller 120 is included within or integrated with an AP and coordinates the links formed by that AP. In some embodiments, the controller 120 is separate from the APs and coordinates the links of multiple APs. The operating environment 100 is an example configuration and there may be a different number of clients, APs, controllers, and/or other devices in further examples.

As used herein, an AP along with the client devices associated with the AP (e.g., the client devices within the coverage area or cell of the AP) is referred to as a Basic Service Set (BSS). In the illustrated example, the first AP 102 is the serving or current AP for the client device 110 within the first cell 112. The APs may communicate with one or more client devices on the downlink (DL) and uplink (UL). The DL is the communication link from an AP to a client device 110, and the UL is the communication link from a client device 110 to an AP. In some cases, a client device 110 may also communicate peer-to-peer with another client device.

As shown in FIG. 1, the client device 110 and the APs are MLDs and each include one or more STAs. The client device 110 uses the STAs to form links with the AP STAs. For example, the client device 110 may use a first STA to form a first wireless link 130 with a corresponding STA of the first AP 102, and the client device 110 may use a second STA to form a second wireless link 132 with another STA of the first AP 102. Each STA may include Physical (PHY)-layer and lower-Media Access Control (MAC) components. The MLDs may also include an upper-MAC for coordinating the multiple STAs (or links) that are part of the MLD. The STAs can use different frequency bands for various wireless links. For example, the first wireless link 130 may be formed using a 5 GHz band and the second wireless link 132 may be formed using a 6 GHz band. These are example frequency bands and the wireless links may use any suitable frequency bands, including 2.4 GHz, 5 GHz, 6 GHz, or other bands.

In general, the AP(s) and the client device 110 may form any suitable number of links for communication using any suitable frequencies. In some instances, the client device 110 may form links with one AP (e.g., the first link 130 and the second link 132 with the first AP 102). In other instances, the client device 110 may form links with multiple APs (e.g., the first link 130 and the second link 132 with the first AP 102 and a third link 134 with the second AP 104). As a result, the client device 110 may communicate with one or more APs over multiple links using different frequencies. Additionally, setup links may not always be active or otherwise useable. For example, the third link 134 may be setup with the second AP 104 as part of roaming preparation, but the roaming execution may not have occurred yet. After roaming execution to the second AP 104, the third link 134 becomes useable for data communication.

The controller 120 may provide coordination and control for the APs. For example, the controller 120 may handle adjustments to radio frequency power, channels, authentication, association, and security for the APs. The controller 120 may also coordinate the links formed by the client device(s) 110 with the APs. For example, the controller 120 may coordinate when the client device 110 and an AP communicate over a link using a particular frequency, the type of data communicated over a particular link, when the client device 110 and the AP form or terminate certain links, and/or when the client device 110 and AP (pre)-associate with each other to (pre)-establish certain links.

The client device 110 may be referred to as a STA MLD or non-AP MLD (e.g., a STA or client device acting as an MLD) and the first AP 102 or second AP 104 may be referred to as an AP MLD (e.g., an AP that acts as an MLD). The STA MLD and AP MLD are generally representative of any device capable of performing multi-link (ML) operations. An MLD may generally be classified based on whether it is a single radio MLD or multi-radio MLD. Single radio MLDs generally use a single radio (e.g., STA) to switch between one or more links. One category of single radio MLDs is Enhanced Multi-Link Single Radio (eMLSR). eMLSR devices generally operate one main wireless radio that can transmit and/or receive data frames on a given link, but can listen in low capability on a set of links when the device is not actively transmitting or receiving. Multi-radio MLDs may generally be classified into the following two types: (i) simultaneous transmission and reception (STR) MLD and (ii) non-STR MLD. For STR MLDs, a transmission on one link does not affect the operations of frame reception and clear channel assessment (CCA) on other links. For non-STR MLDs, the operation on one link may be restricted by the operation on another link. For example, a transmission on one link may not be allowed if it will cause reception interruption on another link.

In certain embodiments, the operating environment 100 enables the client device 110 to utilize seamless roaming techniques such as roaming without performing re-association with one or more APs, receiving neighbor reports to determine a target AP, and so on. As the client device 110 moves away from the coverage of an AP, the client device 110 may perform roaming preparation procedures to add links with a target AP MLD as it roams in the coverage of target APs within the SMD 106 to continue connectivity with the network. In certain embodiments, the beacons’ signal strength (e.g., RSSIs) from APs in the client device 110 roaming path acts as triggers for initiating roaming preparation to add links with target AP MLD(s).

The client device 110 may have enabled operating modes and configured related operating parameters with the first AP 102 for one or more links. These operating modes can include DPS, DUO, PUO, NPCA, DSO, DBE, LLI, P-EDCA, and the like. Because these operating modes and parameters are setup per link (and not at the AP MLD level) with the serving AP and links setup with a target AP are different links, the operating modes cannot be automatically transferred to the second AP 104 or other target AP.

To enable the client device 110 to continue operating in these modes without added delay after roaming, the techniques described herein enable transfer or negotiation of operating modes and related operation parameters with the target AP during seamless roaming. These operating modes and related operation parameters can be transferred or negotiated with the target AP MLD as part of the roaming preparation phase and, in some cases, the roaming execution phase (e.g., when changes occur after roaming preparation or in case of last-minute roaming using roaming execution or direct roaming through the target AP).

In some embodiments, the client device 110 has established PUO schedules with the serving AP for one or more links, for example using Channel Usage with peer-to-peer (P2P) Target Wake Time (TWT) or another mechanism. The client device 110 may want to transfer or setup the unavailability schedule with a target AP instead of re-establishing these PUO schedules on the target AP MLD after roaming (which could cause disruption to the PUO schedules and add additional delay and overhead for setup/(re)negotiation). To enable the target AP to be aware of scheduled unavailability, the client device 110 can request to transfer or (re)negotiate any PUO schedules that it desires to be moved to the target AP MLD links. The request can be part of roaming preparation and/or roaming execution. In some implementations, the request is part of a roaming request sent directly to the target AP.

Furthermore, if the client device 110 has enabled EPCS priority access with the current AP (the first AP 102), it is desirable to transfer that state to the target AP (the second AP 104). As part of roaming preparation, roaming execution, and/or part of a roaming request sent directly to a target AP, the client device 110 can request to transfer its EPCS enabled state or alternatively request to enable EPCS priority access on the target AP. The serving AP then facilitates transfer of the EPCS priority access state or attempts to enable EPCS priority access on the target AP MLD.

In some embodiments, the roaming execution can be performed via the serving AP or directly with the target AP. In some embodiments, a client device can perform last-minute or urgent roaming directly with the target AP. In such cases, the client device 110 can request to transfer or (re)negotiate operating modes and related operation parameters as part of roaming exchange directly with the target AP. Similarly, in such cases, the client device 110 can request to transfer or (re)negotiate any PUO schedules that it desires to be moved to the target AP MLD links as part of roaming exchange directly with the target AP MLD. Furthermore, in such cases, the client device 110 can request to transfer its EPCS enabled state or alternatively request to enable EPCS priority access on the target AP as part of roaming exchange directly with the target AP MLD.

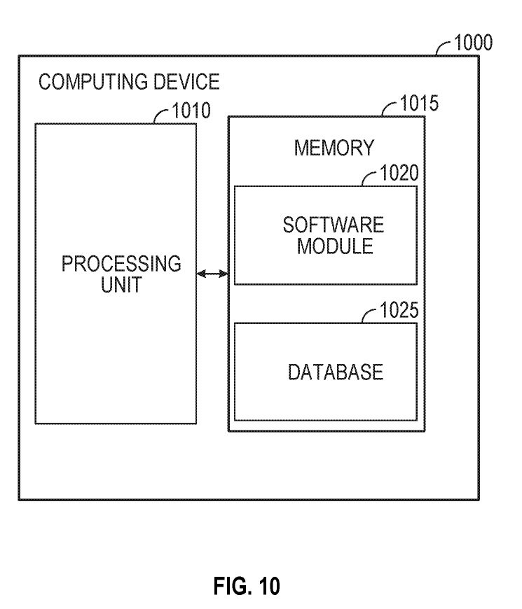

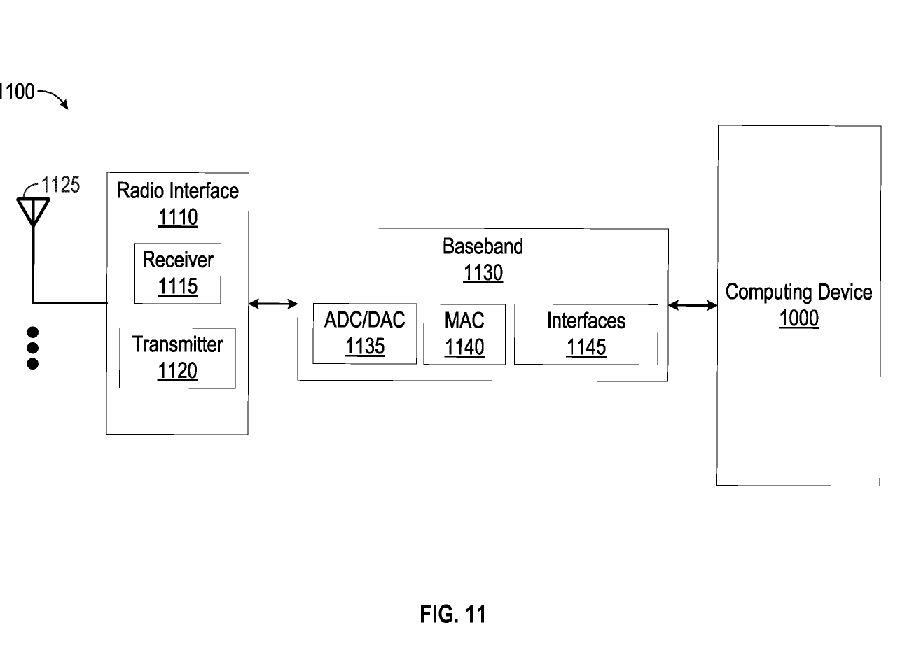

The elements described above of the operating environment 100 (e.g., the first AP 102, the second AP 104, the SMD-ME 108, the client device 110, the controller 120, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 10 and 11, the elements of the operating environment 100 may be practiced in a computing device 1000 and/or communications device 1100.

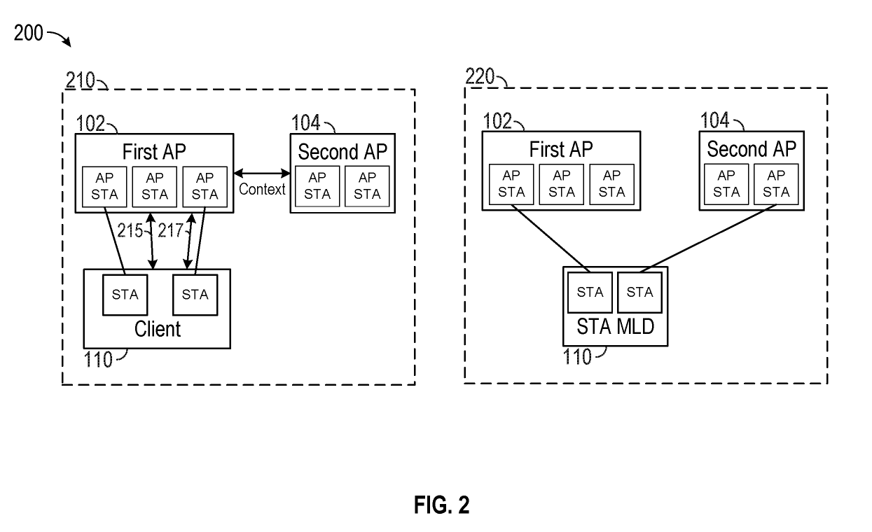

FIG. 2 illustrates an example seamless roaming process 200 with the client device 110 roaming from the first AP 102 (serving AP) to the second AP 104 (target AP) within the SMD 106. The seamless roaming process 200 includes a roaming preparation procedure and roaming execution procedure. The roaming preparation procedure involves coordination between a serving AP and one or more target APs to add one or more links at the target APs and reserve resources at the target APs (such as Stream Classification Service (SCS) and Block Acknowledge resources). After roaming preparation is complete, the client device 110 subsequently initiates roaming execution to complete its roaming transition. The two phases of the roaming procedure minimize connection disruption during roaming and provide faster and more seamless roaming. As part of the context exchange or in a separate communication, the second AP 104 indicates the outcome of the roaming preparation to the first AP 102.

Roaming preparation and execution is shown in phase 210. During the phase 210, the client device 110 and the first AP 102 perform an SMD BSS transition (ST) preparation exchange 215. The ST preparation exchange 215 includes an ST preparation request sent from the client device 110 to the first AP 102, indicating that the client device 110 intends to roam to one or more target APs and requests to prepare or add links on those target APs.

In response to the ST preparation request, the first AP 102 sends context related to the client device 110 to the second AP 104 and potentially other target APs indicated in the request or identified by the first AP 102. The context transferred may include link setup information, parameters related to block acknowledgement agreements setup for the client device 110, SCS streams setup for the client device 110, mirrored SCS (MSCS) streams setup for the client device 110, TWT agreements setup for the client device 110, TID-to-link mapping (TTLM) agreements setup for the client device 110, security association context associated with the client device 110, capabilities of the client device 110, and/or other context information.

The ST preparation exchange 215 further includes an ST preparation response sent from the first AP 102 to the client device 110 indicating whether the roaming preparation request succeeds, for example indicating whether one or more target APs accepted the roaming preparation request and the set of links that were added on the target AP. If at least one target AP (the second AP 104 in the illustrated embodiment) accepts the roaming request and has setup one or more links for the client device 110, the preparation procedure in phase 210 is considered successful. The ST preparation exchange 215 can further include additional ST requests, context transfers, and ST responses if the roaming request fails or to provide multiple options to the client device 110.

### Operating Mode Transfer or Negotiation During Roaming Preparation

The client device 110 can transfer or negotiate operating modes and parameters for links setup with the target AP during roaming preparation using one of two approaches.

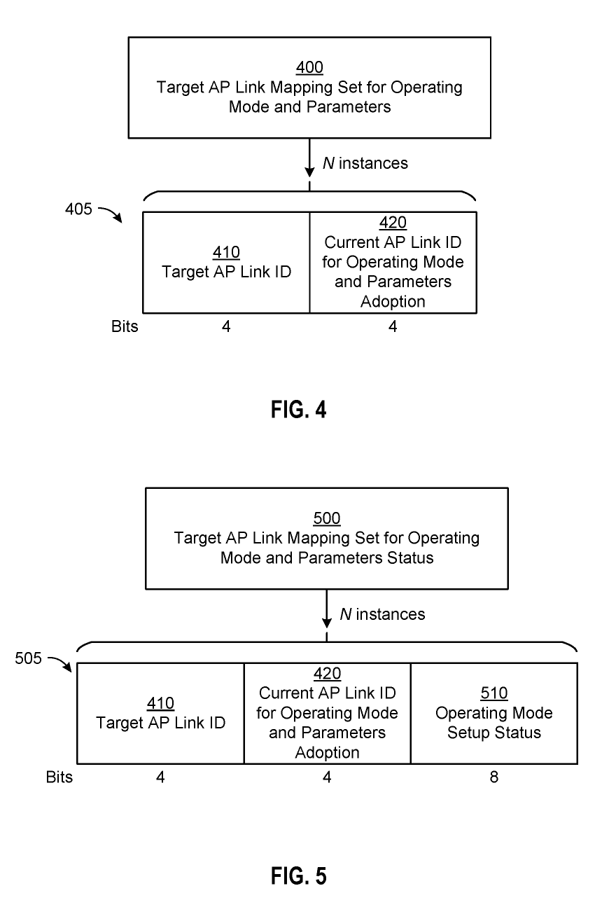

In a first approach using mapping, the client device 110 indicates a mapping between links of the serving AP to the links of target AP MLD for transferring operating modes and related operation parameters. For example, if the current AP MLD has setup links on 2.4 GHz (Link 1), 5 GHz (Link 2), and 6 GHz (Link 3), and the target AP MLD has setup links on 5 GHz (Link 1), 5 GHz (Link 2), and 6 GHz (Link 3), the client device 110 can request to adopt or otherwise use operating modes and operation parameters for Link 1 and Link 2 of the target AP MLD from Link 2 of the serving AP MLD, and Link 3 of the target AP MLD from Link 3 of the serving AP MLD. An example operating mode mapping indication format is illustrated and described in further detail herein with respect to FIG. 4. The serving AP MLD transfers operating modes and related parameters from current links with the serving AP to links of the target AP based on this mapping in the ST preparation request. Alternatively, the serving AP MLD can determine the link mapping for the purpose of mapping operating modes and operation parameters automatically based on matching frequency bands between the serving AP links and target AP links (e.g., mapping serving AP 2.4 GHz links to target AP 2.4 GHz links, serving AP 5 GHz links to target AP 5 GHz links, and serving AP 6 GHz links to target AP 6 GHz links).

When the client device 110 initiates transfer or negotiation of operating modes using link mapping in the ST preparation request, the serving AP indicates the status of the operating mode transfer/(re)negotiation in the ST preparation response. For example, the response indicates whether operating modes were successfully transferred to the setup links with the target AP, with accept or reject status provided per link of the target AP MLD. An example operating mode status indication format is illustrated and described in further detail herein with respect to FIG. 5.

In a second approach using Per-STA Profiles, the client device 110 requests to enable one or more operating modes and operation parameters for one or more added links of the target AP in the Per-STA Profile for that link (e.g., in a Reconfiguration ML element) in the ST preparation request. In example implementations, the client device 110 includes a UHR Operating Mode Notification element (also referred to as a UHR Mode Change element) in the STA Profile of the Per-STA Profile for each added link requested with the target AP to request enabling one or more operating modes and related parameters for the corresponding requested link of the target AP MLD. The target AP then attempts to setup these operating modes with the provided operating mode parameters for the requested link(s) that were successfully added at the target AP for the client device 110.

When the client device 110 requests the operating modes using the Per-STA Profile for the links, the ST preparation response signals (e.g., in the Basic ML element for each added link and based on the response from the target AP) whether operating modes and parameters were accepted and successfully setup for an added link by providing a status in the STA Profile of Per-STA Profile for that link. Alternatively, in case of successful setup, no status is provided, and the absence of status is considered as successful operating modes setup. The STA Profile can also signal when the operating modes and parameters were rejected with a reject status (e.g., in a UHR Operating Mode Notification element included in the STA Profile of Per-STA Profile for that link). In some embodiments, the status indication for operating modes and parameters setup at the accepted links of the target AP MLD can be indicated as one status for all accepted links (e.g. indicating a success or failure) or indicated as per-link status (e.g. indicating a success or failure for each link). The status indication is provided outside of the Basic ML element in some embodiments.

### Unavailability Schedule Transfer or Negotiation During Roaming Preparation

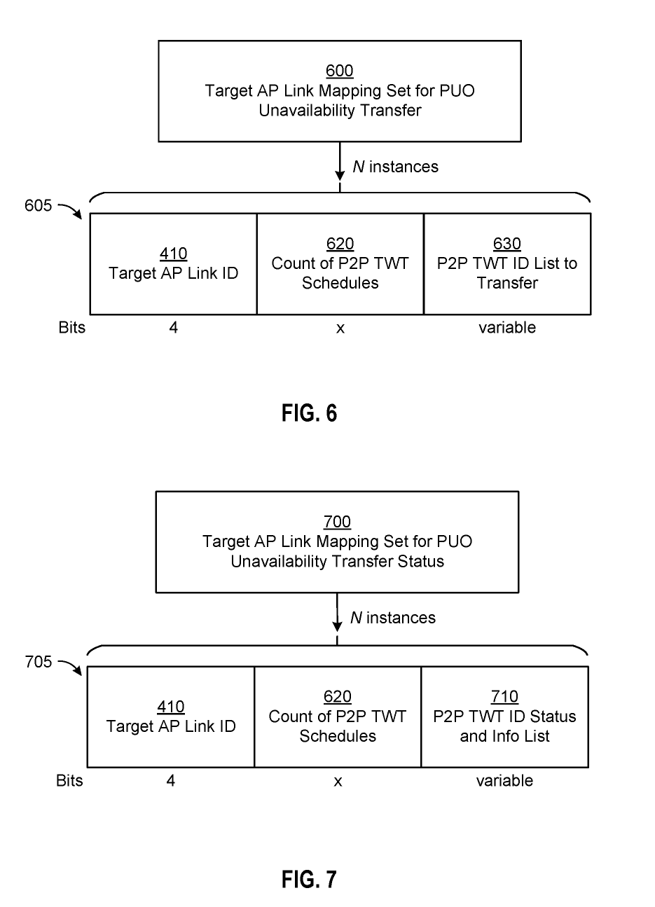

The client device 110 can also transfer or negotiate unavailability periods during roaming preparation. In a first approach using mapping, the client device 110 sends in the ST preparation request link mapping indicating where it wants the PUO schedules to be transferred. For example, the client device 110 can indicate, for each target AP link, any existing PUO schedule (e.g., P2P TWT schedule) it wants to transfer (e.g., indicated based on a list of TWT IDs). Alternatively, the client device 110 can indicate to transfer all PUO schedules from a current AP MLD link to a target AP MLD link. An example unavailability period mapping indication format is illustrated and described in further detail herein with respect to FIG. 6.

In example implementations, the start time of PUO P2P TWT is adjusted based on the Timing Synchronization Function (TSF) offset for the link where the schedule is transferred. The TSF offset of the target AP links can be returned in the ST preparation response for the client device 110 to adjust the start time of PUO schedules. In some embodiments, the TSF offset for each accepted link of the target AP may be provided in the STA Info field of the Per-STA Profile of that link in the Basic ML element (or another ML element), wherein the presence of the TSF offset field is indicated using a presence bit in the STA Control field in the Basic ML element. In some embodiments, the existing TSF Offset field in the STA Info field of the Per-STA Profile in the Basic ML element can be used to provide this TSF Offset. In some embodiments, the TSF Offset can be provided for each accepted link at the target AP MLD with respect to the link of the serving AP MLD where the ST preparation response is transmitted (or with respect to another reference link of the serving AP MLD). In some embodiments, a separate element/subelement can be included in the STA Profile for each accepted link providing the TSF Offset for that link. For example, a TSF subelement or a TSF element can be included in the STA Profile that includes a TSF Offset field. The TSF Offset field could be anywhere between one octet and eight octets based on the granularity supported for TSF offset reporting. Alternatively, a revised start time of transferred PUO schedules is returned already adjusted based on the TSF time of the target AP link where that PUO schedule is transferred. The ST preparation response may still provide the TSF offset information for accepted links at the target AP MLD in example implementations.

The ST preparation response indicates the status of whether the indicated PUO schedule was transferred to the requested link of the target AP, with accept or reject status provided. An example unavailability period status indication format is illustrated and described in further detail herein with respect to FIG. 7.

In a second approach using Per-STA Profiles, the client device 110 negotiates the PUO schedules to setup on links with the target AP. For example, in the Per-STA Profile subelement of the requested link in the roaming request (e.g. in the Per-STA Profile in the Reconfiguration ML element included in the ST preparation request), the client device 110 indicates the P2P TWT element for setting up the PUO unavailability schedules on that link. In the ST preparation response, the Per-STA Profile for each added link (e.g., in Basic ML element or another element) provides whether the requested PUO schedule was setup on that link (accept/reject status).

### EPCS Priority Access Transfer During Roaming Preparation

The client device 110 can request to transfer or otherwise enable EPCS access with the target AP via the ST preparation request. If the client device 110 has enabled EPCS priority access with the current AP, it can request to transfer its EPCS enabled state or alternatively request to enable EPCS priority access on the target AP. The serving AP facilitates the transfer, such as via context transfer to the target AP, and indicates whether EPCS access is enabled or disabled with the target AP in the ST preparation response. If EPCS priority access is successfully enabled on the target AP, an EPCS Priority Access Multi-Link element can be included in the ST preparation response to provide the client with the set of EPCS Enhanced Distributed Channel Access (EDCA) and Multi-User-EDCA (MU-EDCA) parameters to be used with the target AP MLD.

### Operating Mode, Unavailability Schedule, and EPCS Access Transfer During Roaming Execution

Following successful completion of the ST preparation exchange 215, the first AP 102 and the client device 110 can perform a roaming execution procedure to enable the client device 110 to transition to the second AP 104. Roaming execution involves the client device 110 performing an ST execution exchange 217 with the first AP 102. The ST execution exchange 217 completes the roaming execution to the second AP 104. In some embodiments, the roaming execution exchange can also be performed directly with the target AP (not shown in FIG. 2).

In some embodiments, the client device 110 initiates the transfer or negotiation of operating modes and parameters, unavailability schedules, and/or EPCS access via the ST execution request instead of or in addition to the ST preparation request. This may occur when changes happen after roaming preparation or in case of last-minute roaming directly to a target AP without prior preparation (in which case a roaming request/response exchange may be performed directly with the target AP MLD). The client device 110 can use either of the approaches described above (link mapping or Per-STA Profile negotiation) to request operating mode transfer or setup in the ST execution request or in a roaming request sent directly to the target AP. Similarly, the client device 110 can request transfer or negotiation of PUO schedules using either the link mapping approach or the Per-STA Profile approach. The client device 110 can also request to transfer or enable EPCS priority access in the ST execution request or in a roaming request sent directly to the target AP.

The serving AP facilitates the transfer or negotiation of operating modes and parameters, unavailability schedules, and/or EPCS access to the target AP(s), such as via context transfer to the target AP. The context transfer during roaming execution typically includes dynamic context such as Sequence Numbers (SNs) and Packet Numbers (PNs) in addition to any operating mode, unavailability schedule, or EPCS state information requested by the client device 110.

The serving AP also indicates the status of the transfer or negotiation of operating modes and parameters, unavailability schedules, and/or EPCS access via the ST execution response. The status indications follow the same formats and approaches described above for the ST preparation response (e.g., accept/reject status per link for operating modes, transfer status for PUO schedules with TSF offset or revised start time, and EPCS parameters if successfully enabled).

After roaming execution is completed (following the ST execution exchange 217), the client device 110 enters a roaming transition phase 220, in which the client device 110 has established at least one link with the second AP 104 (the target AP) and may maintain at least one link with the first AP 102. Because the operating modes and respective parameters information was provided and/or negotiated during roaming preparation and/or execution, the client device 110 is able to operate in the configured operating modes via the links setup with the target AP without additional delay or signaling overhead. Furthermore, the target AP is aware of when the client device 110 will be unavailable when PUO is active because of the transfer and/or negotiation of unavailability schedules. If EPCS priority access was transferred or enabled, the client device 110 can utilize priority access with the target AP. The client device 110 fully transitions to the target AP once the links with the serving AP are deleted.

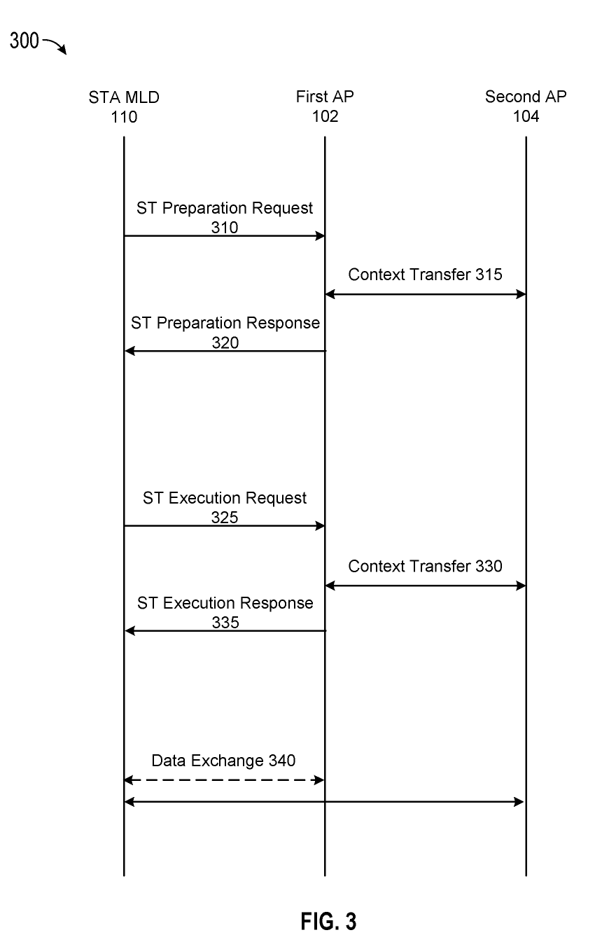

FIG. 3 is a message exchange diagram illustrating a procedure 300 for operating modes and unavailability schedules transfer during roaming. The illustrated procedure 300 shows communications between the client device 110, the first AP 102 (serving AP), and the second AP 104 (target AP) during a seamless roaming process.

At some point prior to the message exchanges illustrated in FIG. 3, the client device 110 may determine to initiate a seamless roaming process. Initiating a seamless roaming process by the client device 110 may be triggered upon receiving a report from the first AP 102. Such report may be generated based on observed network conditions and parameters associated with the quality of connection of the client device 110 with the first AP 102 and/or other APs that are available. Alternatively, the client device 110 may determine to initiate seamless roaming based on RSSI measurements, trajectory predictions, BSS load, or other factors. Upon making this determination, the client device 110 may optionally perform initial signaling exchange with the first AP 102, such as requesting a Neighbor Report from the first AP 102 that includes identification of several available target APs.

Once the client device 110 determines to initiate seamless roaming, the client device 110 sends an ST preparation request to the first AP 102 in stage 310. The ST preparation request may be implemented as a UHR Link Reconfiguration Request frame or another signaling frame. For example, the UHR Link Reconfiguration Request may include one or more Reconfiguration ML elements indicating links to be added or setup with one or more candidate target APs along with (optionally) a preference order of desired candidates. The ST preparation request may further include other roaming related indication and parameters such as a preparation indication, a Roaming SN, a context transfer indication indicating the set of contexts to be transferred, a resource reservation request, a context negotiation request, and/or other roaming context information.

The client device 110 can include operating mode transfer or negotiation information in the ST preparation request. In the approach with link mapping, the client device 110 includes a Target AP MLD Link Mapping Set for operating mode parameters that provides mapping between each target AP MLD link and the link of the serving AP MLD from where to adopt operating modes and parameters. For example, the client device 110 may indicate that for target AP Link 1, the operating modes and parameters should be adopted from serving AP Link 2. The client device 110 can provide such mapping for each link being added with the target AP. Alternatively, the serving AP MLD can determine this mapping automatically based on matching frequency bands between links.

In the Per-STA Profile negotiation approach, the client device 110 includes a UHR Operating Mode Notification element (or UHR Mode Change element) in the STA Profile of the Per-STA Profile for each link being added with the target AP. The UHR Operating Mode Notification element indicates which operating modes the client device 110 requests to enable (e.g., DPS, DUO, PUO, NPCA, DSO, DBE, LLI, P-EDCA) and the related operating mode parameters for each of those modes. The operating modes setup at the target AP MLD links can be used when the links becomes active and after the client device 110 performs the roaming transition to the target AP.

The client device 110 can include unavailability schedule transfer or negotiation information in the ST preparation request. In the approaching including transferring with link mapping, the client device 110 indicates for each target AP MLD link any existing PUO P2P TWT schedule it wants to transfer. This can be indicated based on a list of TWT IDs identifying specific PUO schedules to transfer. Alternatively, the client device 110 can indicate to transfer all PUO schedules from a specific current AP MLD link to a specific target AP MLD link (e.g., transfer all PUO schedules from serving AP 5 GHz link to target AP 5 GHz link). In the second approach using Per-STA Profiles, the client device 110 includes a P2P TWT element in the Per-STA Profile subelement of the added link to request setup of new PUO unavailability schedules on that link.

If the client device 110 has enabled EPCS priority access with the first AP 102 and desires to maintain this priority access with the target AP, the client device 110 can include a request to transfer its EPCS enabled state or alternatively request to enable EPCS priority access on the target AP in the ST preparation request.

After receiving the ST preparation request in stage 310, the first AP 102 may determine a final list of candidate target APs. This list may include the second AP 104 and potentially other target APs. Once the list is determined, the first AP 102 performs context transfer in exchange 315 with the candidate target APs (including the second AP 104) to transfer one or more roaming context parameters and reserve resources on the candidate target APs, and/or to perform negotiation of one or more roaming context parameters with the candidate target APs and to setup link(s) with the candidate target APs.

The roaming preparation and context transfer may include transfer of near static context (or any selected context information) to one or more candidate target APs for roaming in the future, pre-setting up of links on one or more candidate target APs (with the links not yet activated and 802.1x port not yet open for data transfer), and optional resource reservation for one or more resources on the candidate target APs for a time period (such as a Roaming Execution Timer duration). The resources reserved may include pre-assignment of setup links for the client device 110, reserving QoS resources for one or more SCS streams as requested by the client device 110 or selected by the first AP 102, reserving resources for TWT agreements (either existing TWT agreements that are requested to be transferred to specific links or new TWT agreements that are requested to be negotiated), reserving Block Acknowledgment resources, and/or reserving any other resources requested by the client device 110 or selected by the first AP 102. The context transferred may include parameters related to block acknowledgement agreements setup for the client device 110, SCS streams setup for the client device 110, MSCS streams setup for the client device 110, TWT agreements setup for the client device 110, TTLM agreements setup for the client device 110, security association context associated with the client device 110, capabilities of the client device 110, and/or other context information. The static context to be transferred to candidate target APs may be specified by the client device 110 and the first AP 102 (negotiated between them).

When the client device 110 has requested operating mode transfer using the link mapping approach, the first AP 102 transfers the operating modes and parameters from the indicated serving AP links to the corresponding target AP links in the context transfer to the second AP 104. For example, if the client device 110 requested to adopt operating modes from serving AP Link 2 (5 GHz) to target AP Links 1 and 2 (both 5 GHz), the first AP 102 transfers the enabled operating modes (e.g., DPS, NPCA, DSO, DBE) and their associated parameters configured on serving AP Link 2 to the second AP 104 for setup on target AP Links 1 and 2. The second AP 104 attempts to setup these operating modes with the provided parameters on the requested links.

When the client device 110 has requested operating mode negotiation using the Per-STA Profile approach, the first AP 102 forwards the operating mode setup request (including the UHR Operating Mode Notification element with the requested operating modes and parameters) to the second AP 104 in the context transfer. The second AP 104 evaluates whether it can support the requested operating modes with the specified parameters on each added link and prepares an accept or reject response.

When the client device 110 has requested PUO schedule transfer using the link mapping approach, the first AP 102 transfers the specified PUO P2P TWT schedules to the second AP 104 in the context transfer. The first AP 102 indicates which PUO schedules (identified by TWT IDs) should be setup on which target AP links. The TSF offset between the serving AP link and target AP link is determined and either provided to enable the client device 110 to adjust the PUO start time, or used by the second AP 104 to calculate a revised start time for the transferred PUO schedule based on the TSF time of the target AP link. The second AP 104 evaluates whether it can accommodate the requested PUO schedules on the specified links and prepares an accept or reject response.

When the client device 110 has requested PUO schedule negotiation using the Per-STA Profile approach, the first AP 102 forwards the P2P TWT element requesting new PUO schedule setup to the second AP 104 in the context transfer. The second AP 104 evaluates the requested PUO parameters and prepares an accept or reject response.

When the client device 110 has requested to transfer or enable EPCS priority access, the first AP 102 transfers the EPCS enabled state or requests to enable EPCS priority access on the second AP 104 in the context transfer. If the second AP 104 successfully enables EPCS priority access for the client device 110, it prepares the EPCS EDCA and MU-EDCA parameters to be provided in the response.

Following the context transfer in exchange 315, the first AP 102 sends an ST preparation response to the client device 110 in stage 320. The ST preparation response may include an indication of one or more candidate target APs (such as a list of candidate target APs that may be listed in preference order) that are prepared for roaming, an indication of a set of one or more static context parameters that were transferred to the candidate target APs, an indication of one or more context parameters that were negotiated with the candidate target APs, an indication of resources reserved at the candidate target APs (e.g., links that are added with the target APs), an Association Identifier (AID) assigned to the client device 110, and/or a Roaming Allowance Duration (RAD) or Roaming Execution Timer value.

In embodiments where a UHR Link Reconfiguration Request is used for roaming preparation, a corresponding UHR Link Reconfiguration Response may include ML element(s) (e.g., Basic Multi-link element or Reconfiguration ML element) for one or more target APs that are prepared and roaming context information that includes one or more of: status (e.g., accept/reject) for roaming preparation, a roaming preparation indication, a Roaming SN, context transfer indication that indicates the set of context that were transferred, context negotiation indication that indicates one or more context parameters that were negotiated with the candidate target APs, resource reservation indication indicating the set of resources reserved, RAD/Roaming Execution Timer, and/or other information. The Roaming SN may be used to tie the roaming preparation phase with a subsequent roaming execution phase. If at least one candidate target AP (the second AP 104 in the illustrated embodiment) accepts the ST preparation request, the preparation phase is considered successful. Once the ST preparation response is received by the client device 110, the roaming preparation phase may be considered complete.

The ST preparation response indicates the status of operating mode transfer or negotiation based on the response received from the second AP 104. When the link mapping approach was used, the serving AP signals accept or reject status per link of the target AP MLD for adopting the operating modes and parameters indicated in the request. For example, the response may indicate that for target AP Link 1, the requested operating mode transfer from serving AP Link 2 was accepted, while for target AP Link 3, the transfer was rejected.

When the Per-STA Profile approach was used, the ST preparation response provides status in the STA Profile of Per-STA Profile for each added link. If operating modes and parameters were accepted and successfully setup for an added link, a success status is provided in the STA Profile (e.g., in a UHR Operating Mode Notification element). Alternatively, in case of successful setup, no status is provided and the absence of status is considered as successful operating mode setup. If operating modes and parameters were rejected, a reject status is provided in the UHR Operating Mode Notification element included in the STA Profile of Per-STA Profile for that link.

The ST preparation response indicates the status of PUO schedule transfer or negotiation based on the response received from the second AP 104. When the link mapping transfer approach was used, the response indicates whether each indicated PUO schedule was successfully transferred to the requested link of the target AP with accept or reject status. The response also includes either the TSF offset of the target AP links to enable the client device 110 to adjust the start time of PUO schedules, or a revised start time for each transferred PUO schedule already adjusted based on the TSF time of the target AP link where that PUO schedule is transferred. When the Per-STA Profile negotiation approach was used, the response provides whether the requested PUO schedule was setup on each added link with accept or reject status in the Per-STA Profile for that link.

If the client device 110 requested to transfer or enable EPCS priority access, the ST preparation response indicates whether EPCS access is enabled or disabled with the target AP. If EPCS priority access was successfully enabled on the second AP 104, an EPCS Priority Access Multi-Link element is included in the ST preparation response to provide the client device 110 with the set of EPCS EDCA and MU-EDCA parameters to be used with the target AP MLD.

Thereafter, the client device 110 may determine a target AP to roam to from among the list of candidate target APs that are prepared for SMD roaming using exchanges described in stage 310 and stage 320. For example, the client device 110 may select the second AP 104 as the target AP to roam to. This determination may be based on RSSI measurements, location and trajectory information, channel load observations, preference order provided in the ST preparation response, and/or other factors. Once the client device 110 determines the target AP, the roaming execution phase may be triggered when the client device 110 sends an ST execution request to the first AP 102 in stage 325.

Using the ST execution request, the client device 110 may send a roaming execution request (e.g., an Add Link Request, a UHR Link Reconfiguration Request, etc.) to the first AP 102 to request roaming execution to the selected target AP (the second AP 104). The ST execution request may include roaming context information that includes one or more of: a field for execution indication, a Roaming SN to tie the roaming execution phase with the roaming preparation phase, a context transfer indication indicating set of (dynamic) context to be transferred, context negotiation indication that indicates one or more context parameters to negotiate with the target AP, and/or other information.

In some embodiments, the client device 110 can initiate or update operating mode transfer or negotiation, unavailability schedule transfer or negotiation, and/or EPCS priority access transfer or enablement in the ST execution request instead of or in addition to the ST preparation request. This may occur when changes to operating modes or PUO schedules occur after roaming preparation was completed, or in case of last-minute roaming where the client device 110 roams directly to a target AP without prior preparation. The client device 110 can use the link mapping approaches or the Per-STA Profile approaches as described above for the ST preparation request. The ST execution request follows similar formats and includes similar information elements as described for the ST preparation request above.

After the first AP 102 receives the ST execution request in stage 325, context transfer in exchange 330 may take place between the first AP 102 and the target AP (the second AP 104). This exchange may be performed according to any known or to be developed signaling procedure whereby the first AP 102 confirms the roaming with the selected target AP and exchanges dynamic context (e.g., SN and/or Packet Number (PN)) with the selected target AP. During the dynamic context transfer, in parallel, the target AP (the second AP 104) may initiate a Distribution System (DS) mapping change to switch the data path for the client device 110 from the first AP 102 to the second AP 104. The DS mapping change may be completed via signaling exchange between the second AP 104 and the DS, enabling the network to route data traffic for the client device 110 to the second AP 104 rather than the first AP 102.

When the client device 110 has requested operating mode transfer or negotiation, unavailability schedule transfer or negotiation, and/or EPCS priority access transfer or enablement in the ST execution request, the first AP 102 facilitates these requests in the context transfer in exchange 330 following the same procedures described above for context transfer during roaming preparation (exchange 315). The second AP 104 processes the requests and prepares responses indicating accept or reject status for each requested operating mode, PUO schedule, and EPCS access enablement.

The first AP 102 sends an ST execution response in stage 335 to the client device 110 to confirm that roaming execution and dynamic context transfer as part of that process is complete. The ST execution response may be implemented as an Add Link Response, a UHR Link Reconfiguration Response, or other signaling frame. The ST execution response may include roaming context information such as: information indicating status of the roaming execution (e.g., accept/reject), an execution phase indication, a Roaming SN, a context transfer indication indicating set of context that were transferred to the target AP, Group Keys of the links setup with the target AP, and/or other information.

When operating mode transfer or negotiation, unavailability schedule transfer or negotiation, and/or EPCS priority access transfer or enablement was requested in the ST execution request, the ST execution response indicates the status following the same formats and approaches described above for the ST preparation response. This includes accept/reject status per link for operating modes, transfer status and TSF offset (or revised start time) for PUO schedules, and EPCS parameters if successfully enabled.

Following the ST execution response in stage 335, the first AP 102 may optionally cancel resources reserved on other candidate target APs (which occurred along with static context transfer during the context transfer in exchange 315). Alternatively, the resource reservation (and links setup) on other candidate target APs can expire automatically (e.g., upon expiration of a timer which may be the same or different than the RAD). The client device 110 can exchange data with the second AP 104 (and optionally the first AP 102) at stage 340. Because operating modes, unavailability schedules, and EPCS priority access (if applicable) were transferred or negotiated during roaming preparation and/or execution, the client device 110 can immediately utilize these configurations with the second AP 104 without additional setup delay or signaling overhead.

FIG. 4 illustrates an operating mode mapping indication format 400 that may be included in an ST preparation request, ST execution request, or roaming request sent directly to a target AP to request transfer of operating modes and parameters from links of the serving AP MLD to links of the target AP MLD using the link mapping approach. The operating mode mapping indication format 400 enables the client device 110 to explicitly specify which operating modes and parameters configured on specific serving AP links should be adopted by specific target AP links.

The operating mode mapping indication format 400 can include any number (N) of per-link operating mode mappings 405, where N corresponds to the number of links being requested, added, or setup with the target AP MLD for which operating mode transfer is desired. For example, to map the operating modes for three target AP links, the operating mode mapping indication format 400 includes three per-link operating mode mappings 405. In some embodiments, the client device 110 may request operating mode transfer for all links being requested or otherwise added with the target AP, while in other embodiments, the client device 110 may request operating mode transfer for only a subset of the links being added.

A per-link operating mode mapping 405 includes a target AP link ID field 410 indicating the link identifier of the target AP for the mapping and a current AP link ID field 420 indicating the link identifier of the serving AP whose operating modes and parameters will be mapped to the link identified by the target AP link ID field 410. For example, if the current AP MLD has Link 2 operating at 5 GHz with DPS, NPCA, DSO, and DBE operating modes enabled, and the target AP MLD is setting up Link 1 and Link 2, both operating at 5 GHz, the client device 110 may include two per-link operating mode mappings 405: one with target AP link ID field 410 set to Link 1 and current AP link ID field 420 set to Link 2 of the current AP, and another with target AP link ID field 410 set to Link 2 and current AP link ID field 420 set to Link 2 of the current AP. This instructs the serving AP to transfer the operating modes and parameters from its Link 2 to both Link 1 and Link 2 of the target AP.

In some embodiments, the per-link operating mode mapping 405 may also include additional fields (not shown) to indicate a subset of operating modes to transfer rather than all operating modes configured on the current AP link. For example, the client device 110 may specify that only DPS and DSO should be transferred while NPCA and DBE should not be transferred.

FIG. 5 illustrates an operating mode status indication format 500 that may be included in an ST preparation response or ST execution response to indicate the status of operating mode transfer or setup requested using the link mapping approach. The operating mode status indication format 500 provides feedback to the client device 110 regarding whether the target AP successfully setup the requested operating modes on each target AP link, enabling the client device 110 to understand which operating modes are available for use after roaming.

The operating mode status indication format 500 includes any number (N) of per-link operating mode status information 505, where N corresponds to the number of target AP links for which operating mode transfer or setup was requested (or a smaller number if a subset of the links are accepted at the target AP). A per-link operating mode status information 505 includes the target AP link ID field 410 identifying the target AP link for which status is being provided, the current AP link ID field 420 identifying the serving AP link from which operating modes were requested to be transferred, and an operating mode setup status field 510.

The operating mode setup status field 510 indicates whether the target AP link has successfully been configured with the indicated operating modes and parameters. In some embodiments, the operating mode setup status field 510 may indicate one of: accept (indicating successful setup of the requested operating modes and parameters), reject (indicating the target AP was unable or unwilling to setup the requested operating modes and parameters), or partial accept (indicating some but not all requested operating modes were successfully setup). In embodiments where operating mode setup is always successful or where no status is provided for successful setup, the absence of a per-link operating mode status information 505 for a given target AP link may indicate successful operating mode setup for that link.

In some embodiments, when operating mode setup is rejected or partially accepted, the operating mode status indication format 500 or the per-link operating mode status information 505 may include additional information (not shown) indicating which specific operating modes were rejected and optionally reasons for rejection (e.g., insufficient resources, unsupported mode, conflicting configuration).

FIG. 6 illustrates an unavailability period mapping indication format 600 that may be included in an ST preparation request or ST execution request to request transfer of PUO schedules from links of the serving AP MLD to links of the target AP MLD using the link mapping approach. The unavailability period mapping indication format 600 enables the client device 110 to maintain continuity of periodic unavailability schedules during roaming, avoiding disruption to ongoing peer-to-peer communications or other activities that cause the client device 110 to be periodically unavailable.

The unavailability period mapping indication format 600 can include any number (N) of per-link unavailability period mappings 605, where N corresponds to the number of target AP links for which PUO schedule transfer is desired. A per-link unavailability period mapping 605 includes a target AP link ID field 410 identifying the link of the target AP to which PUO schedules should be transferred, a count of P2P TWT schedules field 620 indicating a count of unavailability periods to be transferred to the identified target AP link, and a P2P TWT ID list to transfer field 630 indicating the TWT IDs to transfer to the indicated link.

Each PUO schedule is identified by a unique TWT ID that was assigned when the PUO schedule was originally established with the serving AP. By specifying particular TWT IDs in the P2P TWT ID list to transfer field 630, the client device 110 can selectively transfer specific PUO schedules while allowing other PUO schedules to terminate or be re-established separately. For example, if the client device 110 has three PUO schedules with TWT IDs 1, 2, and 3 on a 5 GHz link of the serving AP, and only wishes to transfer PUO schedules 1 and 3 to a 5 GHz link of the target AP, the count of P2P TWT schedules field 620 would be set to 2 and the P2P TWT ID list to transfer field 630 would include TWT IDs 1 and 3.

In some embodiments, instead of or in addition to specifying individual TWT IDs, the per-link unavailability period mapping 605 may include a field or flag (not shown) indicating that all PUO schedules from a specified serving AP link should be transferred to the target AP link.

In alternative embodiments, similar to operating mode transfer, the serving AP may determine PUO schedule mapping automatically based on matching frequency bands. For example, all PUO schedules from the serving AP’s 5 GHz link may automatically be transferred to the target AP’s 5 GHz link(s) without requiring explicit mapping from the client device 110. This approach is particularly suitable when PUO schedules are driven by radio-specific constraints such as where unavailability on a particular frequency band will continue regardless of which AP the client device 110 is associated with (e.g., known IDC).

FIG. 7 illustrates an unavailability period status indication format 700 that may be included in an ST preparation response or ST execution response to indicate the status of PUO schedule transfer requested using the link mapping approach. The unavailability period status indication format 700 provides feedback to the client device 110 regarding whether the target AP successfully setup the requested PUO schedules on each target AP link, enabling the client device 110 to understand when the target AP is aware of its unavailability periods.

The unavailability period status indication format 700 can include any number (N) of per-link unavailability period status information 705, where N corresponds to the number of target AP links for which PUO schedule transfer was requested. A per-link unavailability period status information 705 includes the target AP link ID field 410 identifying the target AP link for which status is being provided, the count of P2P TWT schedules field 620 indicating the number of PUO schedules for which status is being provided, and a P2P TWT ID Status and Info list 740 indicating whether the unavailability periods have been transferred and successfully negotiated.

The P2P TWT ID Status and Info list 740 may include, for each requested PUO schedule (identified by TWT ID), a status indication (e.g., accept or reject) and optionally additional information related to the transferred schedule. In some embodiments, the additional information may include the revised start time for the PUO schedule adjusted to account for the TSF offset between the serving AP link and the target AP link. Because each link maintains its own TSF timer, the start time of a PUO schedule must be adjusted when transferred from one link to another to maintain the correct periodicity and phase relationship. For example, if a PUO schedule on the serving AP link has a start time of 1000 TSF units, and the target AP link has a TSF offset of +500 units relative to the serving AP link, the revised start time on the target AP link would be 1500 TSF units.

In alternative embodiments, instead of providing a revised start time for each transferred PUO schedule in the P2P TWT ID Status and Info list 740, the response frame containing the unavailability period status indication format 700 may include a TSF offset field (not shown in FIG. 7) that provides the TSF offset for each target AP link. The client device 110 can then calculate the revised start time for each transferred PUO schedule by applying the TSF offset to the original start time. This approach reduces signaling overhead when multiple PUO schedules are transferred to the same target AP link, as the TSF offset need only be signaled once rather than providing a revised start time for each schedule.

When a PUO schedule transfer is rejected (e.g., due to insufficient resources at the target AP, conflicting schedules, or other constraints), the status indication in the P2P TWT ID Status and Info list 740 indicates rejection, and the client device 110 may need to re-establish the PUO schedule after roaming or adjust its behavior accordingly. In some embodiments, the rejection status may include additional information indicating the reason for rejection to assist the client device 110 in determining an appropriate response.

The unavailability period status indication format 700 enables the client device 110 to verify that the target AP is aware of its periodic unavailability, ensuring that the target AP will not waste resources attempting to transmit downlink traffic during periods when the client device 110 is unavailable. This improves network efficiency and reduces unnecessary retransmissions after roaming.

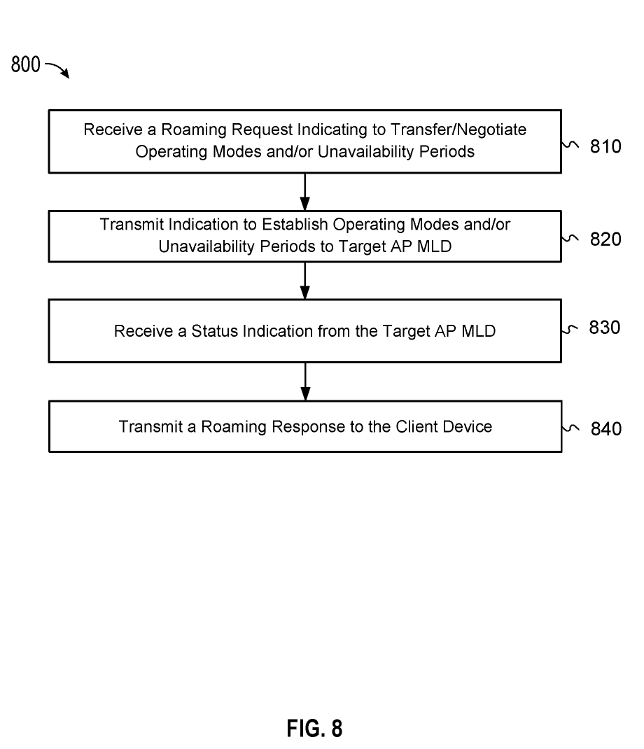

FIG. 8 is a flowchart illustrating a method 800 for facilitating seamless roaming in a wireless network, performed by a serving AP MLD (e.g., the first AP 102). The method 800 enables transfer or establishment of operating modes, operating parameters, and unavailability periods from the serving AP MLD to a target AP MLD (e.g., the second AP) during a roaming process. In other embodiments, the roaming request comprises a roaming request sent directly to a target AP (e.g. for last-minute or urgent roaming).

At stage 810, the serving AP MLD receives, from a non-AP MLD (e.g., the client device 110), a roaming request indicating one or more links to setup with a target AP MLD. The roaming request further includes one or both of: information for establishing one or more operating modes and associated operating parameters for the one or more links, or information for establishing one or more unavailability periods for the one or more links. In some embodiments, the roaming request comprises an ST preparation request. In other embodiments, the roaming request comprises an ST execution request.

The information for establishing the one or more operating modes and associated operating parameters for the one or more links may be provided using one of multiple approaches. In a first approach, the information comprises a link mapping indication that maps one or more links with the serving AP MLD to at least one of the one or more links with the target AP MLD, and operating modes and parameters of the one or more links with the serving AP MLD for transfer based on the link mapping indication. The link mapping indication may include, for example, the operating mode mapping indication format 400 illustrated in FIG. 4. In a second approach, the information comprises a Per-STA Profile subelement for at least one respective link of the one or more links with the target AP MLD, wherein each Per-STA Profile subelement comprises an indication of respective operating modes and parameters for the respective link. The indication of respective operating modes and parameters may comprise, for example, a UHR Operating Mode Notification element.

The information for establishing the one or more unavailability periods for the one or more links may also be provided using one of multiple approaches. In a first approach, the information comprises a link mapping indication that maps one or more links with the serving AP MLD to at least one of the one or more links with the target AP MLD, and unavailability periods of the one or more links with the serving AP MLD for transfer based on the link mapping indication. The link mapping indication may include, for example, the unavailability period mapping indication format 600 illustrated in FIG. 6. The unavailability periods may comprise periodic unavailability schedules associated with PUO mode, such as P2P TWT schedules. In a second approach, the information comprises a Per-STA Profile subelement for at least one respective link of the one or more links with the target AP MLD, wherein each Per-STA Profile subelement comprises an indication of respective unavailability periods for the respective link.

At stage 820, the serving AP MLD transmits, to the target AP MLD, an indication for establishing the one or more operating modes and associated operating parameters, an indication for establishing the one or more unavailability periods, or both. In some embodiments, the serving AP MLD transmits a context transfer message to the target AP MLD comprising the indication for establishing the one or more operating modes and associated operating parameters and/or the indication for establishing the one or more unavailability periods.

When the roaming request includes a link mapping indication for operating modes, the serving AP MLD transfers the operating modes and associated operating parameters from the one or more links with the serving AP MLD to the at least one of the one or more links with the target AP MLD based on the link mapping indication. When the roaming request includes a Per-STA Profile subelement with operating mode information, the serving AP MLD forwards the respective operating modes and parameters indicated in each Per-STA Profile subelement to the target AP MLD for setup on the respective link.

When the roaming request includes a link mapping indication for unavailability periods, the serving AP MLD transfers the unavailability periods from the one or more links with the serving AP MLD to the at least one of the one or more links with the target AP MLD based on the link mapping indication. When the roaming request includes a Per-STA Profile subelement with unavailability period information, the serving AP MLD forwards the respective unavailability periods indicated in each Per-STA Profile subelement to the target AP MLD for setup on the respective link.

When the roaming request includes information for establishing an EPCS priority access state, the serving AP MLD transmits to the target AP MLD an indication to establish the EPCS priority access state.

At stage 830, the serving AP MLD receives, from the target AP MLD, a status indication indicating whether the one or more operating modes and associated operating parameters were successfully established, whether the one or more unavailability periods were successfully established, or both. When the roaming request includes information for establishing an EPCS priority access state, the status indication further indicates whether the EPCS priority access state is established with the target AP MLD.

At stage 840, the serving AP MLD transmits, to the non-AP MLD, a roaming response comprising the status indication. The roaming response may comprise an ST preparation response when the roaming request comprised an ST preparation request, or an ST execution response when the roaming request comprised an ST execution request.

In some embodiments, when one or more unavailability periods were successfully established with the target AP MLD, the roaming response further comprises a TSF offset to adjust a start time of a respective unavailability period or a revised start time for the respective unavailability period, wherein the revised start time has already been adjusted based on a TSF time of the link with the target AP MLD to which the respective unavailability period was transferred. The roaming response may include, for example, the unavailability period status indication format 700 illustrated in FIG. 7, or may include the TSF offset or revised start time in another portion of the roaming response.

In some embodiments, the roaming response further comprises, for operating modes that were successfully established, an operating mode status indication indicating which operating modes were accepted or rejected for each link with the target AP MLD. The operating mode status indication may include, for example, the operating mode status indication format 500 illustrated in FIG. 5.

Following transmission of the roaming response to the non-AP MLD, the non-AP MLD may subsequently perform roaming execution to transition from the serving AP MLD to the target AP MLD. After roaming execution is complete, the non-AP MLD may utilize the one or more operating modes and associated operating parameters on the one or more links with the target AP MLD without additional setup delay. Similarly, the target AP MLD is aware of the one or more unavailability periods and can avoid transmitting downlink traffic to the non-AP MLD during those unavailability periods.

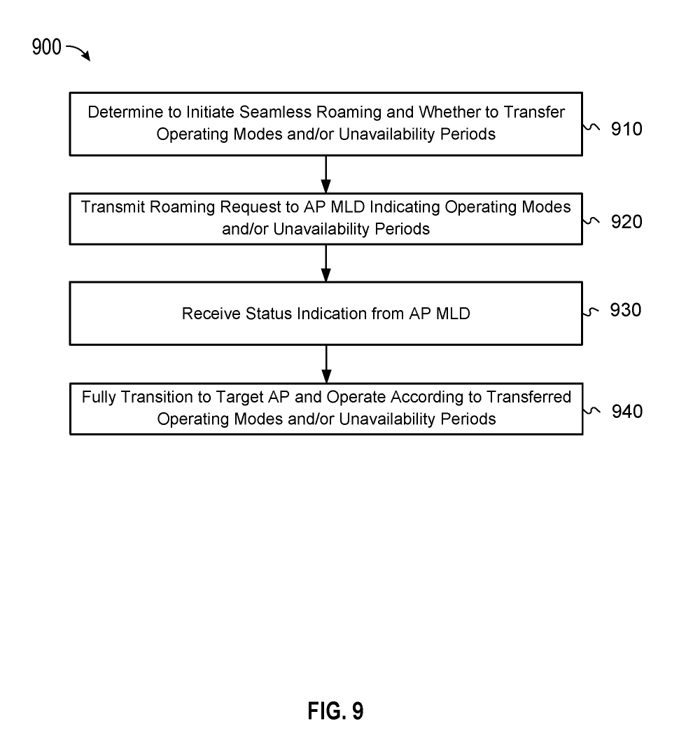

FIG. 9 is a flowchart illustrating a method 900 for performing seamless roaming in a wireless network, performed by a non-AP MLD (e.g., the client device 110). The method 900 enables the non-AP MLD to transfer or establish operating modes, operating parameters, and unavailability periods from links with a serving AP MLD to links with a target AP MLD during a roaming process.

At stage 910, the non-AP MLD determines to initiate seamless roaming to a target AP MLD within an SMD and determines to transfer or establish one or more operating modes and associated operating parameters for one or more links to be setup with the target AP MLD, to transfer or establish one or more unavailability periods for the one or more links, or both. In some embodiments, the non-AP MLD further determines to transfer or establish an EPCS priority access state with the target AP MLD when the non-AP MLD has enabled EPCS priority access with the serving AP MLD.

At stage 920, the non-AP MLD transmits, to the serving AP MLD, a roaming request indicating one or more links to setup with the target AP MLD. The roaming request further includes one or both of: information for establishing one or more operating modes and associated operating parameters for the one or more links, or information for establishing one or more unavailability periods for the one or more links. In some embodiments, the roaming request comprises an ST preparation request transmitted during a roaming preparation phase. In other embodiments, the roaming request comprises an ST execution request transmitted during a roaming execution phase. The roaming request further comprises information for establishing an EPCS priority access state with the target AP MLD in certain embodiments.

At stage 930, the non-AP MLD receives, from the serving AP MLD, a roaming response comprising a status indication indicating whether the one or more operating modes and associated operating parameters were successfully established, whether the one or more unavailability periods were successfully established, or both. The roaming response may comprise an ST preparation response when the roaming request comprised an ST preparation request, or an ST execution response when the roaming request comprised an ST execution request.

At stage 940, the non-AP MLD performs roaming execution to fully transition to the target AP MLD and operates according to the one or more operating modes and associated operating parameters successfully established, according to the one or more unavailability periods successfully established, or both. After fully transitioning to the target AP MLD, the non-AP MLD operates using the one or more operating modes on the one or more links with the target AP MLD without additional setup delay or signaling overhead. Similarly, when one or more unavailability periods were successfully established, the non-AP MLD continues to observe the unavailability periods according to the periodic schedule (adjusted for TSF offset as appropriate), and the target AP MLD is aware of these unavailability periods and avoids transmitting downlink traffic to the non-AP MLD during the unavailability periods.

FIG. 10 is a block diagram of a computing device 1000. As shown in FIG. 10, computing device 1000 may include a processing unit 1010 and a memory unit 1015. Memory unit 1015 may include a software module 1020 and a database 1025. While executing on processing unit 1010, software module 1020 may perform, for example, processes for providing operating modes and parameters, unavailability transfer, and/or EPCS priority access state transfer during seamless roaming. Computing device 1000, for example, may provide an operating environment for the first AP 102, the second AP 104, the SMD-ME 108, the client device 110, the controller 120, and the like. The first AP 102, the second AP 104, the SMD-ME 108, the client device 110, the controller 120, and the like may operate in other environments and are not limited to computing device 1000.

Computing device 1000 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 1000 may comprise any computer operating environment, such as hand-held devices, multiprocessor systems, microprocessor-based or programmable sender electronic devices, minicomputers, mainframe computers, and the like. Computing device 1000 may also be practiced in distributed computing environments where tasks are performed by remote processing devices. The aforementioned systems and devices are examples, and computing device 1000 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from, other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a SOC where each or many of the elements illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 1000 on the single integrated circuit (chip).

FIG. 11 illustrates an implementation of a communications device 1100 that may implement one or more of the first AP 102, the second AP 104, the SMD-ME 108, the client device 110, the controller 120, etc. In various implementations, the communications device 1100 may comprise a logic circuit. The logic circuit may include physical circuits to perform operations described for one or more of the first AP 102, the second AP 104, the SMD-ME 108, the client device 110, the controller 120, etc., for example. As shown in FIG. 11, the communications device 1100 may include one or more of, but is not limited to, a radio interface 1110, baseband circuitry 1130, and/or the computing device 1000.

The communications device 1100 may implement some or all of the structures and/or operations for the first AP 102, the second AP 104, the SMD-ME 108, the client device 110, the controller 120, etc., storage medium, and logic circuit in a single computing entity, such as entirely within a single device. Alternatively, the communications device 1100 may distribute portions of the structure and/or operations using a distributed system architecture, such as a client station server architecture, a peer-to-peer architecture, a master-slave architecture, etc.

A radio interface 1110, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 1110 may include, for example, a receiver 1115 and/or a transmitter 1120. The radio interface 1110 may include bias controls, a crystal oscillator, and/or one or more antennas 1125. In additional or alternative configurations, the radio interface 1110 may use oscillators and/or one or more filters, as desired.

The baseband circuitry 1130 may communicate with the radio interface 1110 to process, receive, and/or transmit signals and may include, for example, an Analog-To-Digital Converter (ADC) for down converting received signals with a Digital-To-Analog Converter (DAC) 1135 for up converting signals for transmission. Further, the baseband circuitry 1130 may include a baseband or PHY layer processing circuit for the PHY link layer processing of respective receive/transmit signals. Baseband circuitry 1130 may include, for example, a MAC processing circuit 1140 for MAC/data link layer processing. Baseband circuitry 1130 may include a memory controller for communicating with MAC processing circuit 1140 and/or a computing device 1000, for example, via one or more interfaces 1145.

In some configurations, PHY processing circuit may include a frame construction and/or detection module, in combination with additional circuitry such as a buffer memory, to construct and/or deconstruct communication frames. Alternatively or in addition, MAC processing circuit 1140 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

1. A method comprising:
receiving, by an access point multi-link device (AP MLD) from a non-AP MLD, a roaming request indicating:
one or more links to setup with a target AP MLD, and
one or both of information for establishing one or more operating modes and associated operating parameters for the one or more links, or information for establishing one or more unavailability periods for the one or more links;
transmitting, to the target AP MLD, an indication for establishing the one or more operating modes and associated operating parameters, an indication for establishing the one or more unavailability periods, or both;
receiving, from the target AP MLD, a status indication indicating whether the one or more operating modes and associated operating parameters were successfully established, whether the one or more unavailability periods were successfully established, or both; and
transmitting, to the non-AP MLD, a roaming response comprising the status indication.

2. The method of claim 1, wherein the information for establishing the one or more operating modes and associated operating parameters for the one or more links comprises:
a link mapping indication that maps one or more links with the AP MLD to at least one of the one or more links with the target AP MLD, and
operating modes and parameters of the one or more links with the AP MLD for transfer based on the link mapping indication.

3. The method of claim 1, wherein the information for establishing the one or more operating modes and associated operating parameters for the one or more links comprises:
a per-station (STA) profile subelement for at least one respective link of the one or more links with the target AP MLD, wherein each per-STA profile subelement comprises an indication of respective operating modes and parameters for the respective link.

4. The method of claim 1, wherein the information for establishing the one or more unavailability periods for the one or more links comprises:
a link mapping indication that maps one or more links with the AP MLD to at least one of the one or more links with the target AP MLD, and
unavailability periods of the one or more links with the AP MLD for transfer based on the link mapping indication.

5. The method of claim 1, wherein the information for establishing the one or more unavailability periods for the one or more links comprises:
a per-STA profile subelement for at least one respective link of the one or more links with the target AP MLD, wherein each per-STA profile subelement comprises an indication of respective unavailability periods for the respective link.

6. The method of claim 1, wherein the roaming response comprises:
a timing synchronization function offset to adjust a start time of a respective unavailability period, or
a revised start time for the respective unavailability period.

7. The method of claim 1, wherein:
the roaming request further comprises information for establishing an emergency preparedness communications service (EPCS) priority access state;
transmitting to the target AP MLD further includes an indication to establish the EPCS priority access state; and
the status indication further indicates whether the EPCS priority access state is established.

8. The method of claim 1, wherein:
the roaming request comprises a seamless mobility domain basic service set transition (ST) preparation request and the roaming response comprises an ST preparation response; or
the roaming request comprises an ST execution request and the roaming response comprises an ST execution response.

9. A system comprising:
a memory storage; and
a processing unit coupled to the memory storage, wherein the processing unit is operative to:
receive, from a non-access point multi-link device (non-AP MLD), a roaming request indicating:
one or more links to setup with a target AP MLD, and
one or both of information for establishing one or more operating modes and associated operating parameters for the one or more links, or information for establishing one or more unavailability periods for the one or more links;
transmit, to the target AP MLD, an indication for establishing the one or more operating modes and associated operating parameters, an indication for establishing the one or more unavailability periods, or both;
receive, from the target AP MLD, a status indication indicating whether the one or more operating modes and associated operating parameters were successfully established, whether the one or more unavailability periods were successfully established, or both; and
transmit, to the non-AP MLD, a roaming response comprising the status indication.

10. The system of claim 9, wherein the information for establishing the one or more operating modes and associated operating parameters for the one or more links comprises:
a link mapping indication that maps one or more current links to at least one of the one or more links with the target AP MLD, and
operating modes and parameters of the one or more current links for transfer based on the link mapping indication.

11. The system of claim 9, wherein the information for establishing the one or more operating modes and associated operating parameters for the one or more links comprises:
a per-station (STA) profile subelement for at least one respective link of the one or more links with the target AP MLD, wherein each per-STA profile subelement comprises an indication of respective operating modes and parameters for the respective link.

12. The system of claim 9, wherein the information for establishing the one or more unavailability periods for the one or more links comprises:
a link mapping indication that maps one or more current links to at least one of the one or more links with the target AP MLD, and
unavailability periods of the one or more current links for transfer based on the link mapping indication.

13. The system of claim 9, wherein the information for establishing the one or more unavailability periods for the one or more links comprises:
a per-STA profile subelement for at least one respective link of the one or more links with the target AP MLD, wherein each per-STA profile subelement comprises an indication of respective unavailability periods for the respective link.

14. The system of claim 9, wherein the roaming response comprises:
a timing synchronization function offset to adjust a start time of a respective unavailability period, or
a revised start time for the respective unavailability period.

15. The system of claim 9, wherein:
the roaming request further comprises information for establishing an emergency preparedness communications service (EPCS) priority access state;
transmitting to the target AP MLD further includes an indication to establish the EPCS priority access state; and
the status indication further indicates whether the EPCS priority access state is established.

16. A non-transitory computer-readable medium that stores a set of instructions which when executed perform a method comprising:
receiving, from a non-access point multi-link device (non-AP MLD), a roaming request indicating:
one or more links to setup with a target AP MLD, and
one or both of information for establishing one or more operating modes and associated operating parameters for the one or more links, or information for establishing one or more unavailability periods for the one or more links;
transmitting, to the target AP MLD, an indication for establishing the one or more operating modes and associated operating parameters, an indication for establishing the one or more unavailability periods, or both;
receiving, from the target AP MLD, a status indication indicating whether the one or more operating modes and associated operating parameters were successfully established, whether the one or more unavailability periods were successfully established, or both; and
transmitting, to the non-AP MLD, a roaming response comprising the status indication.

17. The non-transitory computer-readable medium of claim 16, wherein the information for establishing the one or more operating modes and associated operating parameters for the one or more links comprises:
a link mapping indication that maps one or more current links to at least one of the one or more links with the target AP MLD, and
operating modes and parameters of the one or more current links for transfer based on the link mapping indication.

18. The non-transitory computer-readable medium of claim 16, wherein the information for establishing the one or more operating modes and associated operating parameters for the one or more links comprises:
a per-station (STA) profile subelement for at least one respective link of the one or more links with the target AP MLD, wherein each per-STA profile subelement comprises an indication of respective operating modes and parameters for the respective link.

19. The non-transitory computer-readable medium of claim 16, wherein the information for establishing the one or more unavailability periods for the one or more links comprises:
a link mapping indication that maps one or more current links to at least one of the one or more links with the target AP MLD, and
unavailability periods of the one or more current links for transfer based on the link mapping indication.

20. The non-transitory computer-readable medium of claim 16, wherein the information for establishing the one or more unavailability periods for the one or more links comprises:
a per-STA profile subelement for at least one respective link of the one or more links with the target AP MLD, wherein each per-STA profile subelement comprises an indication of respective unavailability periods for the respective link.
